(19) United States
(12) Patent Application Publication
(10) Pub. No.: US 2013/0103598 A1
(43) Pub. Date: Apr. 25, 2013

(54) DIGITAL DOCUMENT COMPLIANCE SYSTEM

(71) Applicant: Jim Peterson, Littleton, CO (US)

(72) Inventor: Jim Peterson, Littleton, CO (US)

(21) Appl. No.: 13/278,897

(22) Filed: Oct. 21, 2011

(51) Int. Cl. G06Q 99/00

(52) U.S. Cl. 705/317

(57) ABSTRACT

A system for ensuring digital real estate listing documents comply with certain standards is disclosed. The system may include three processors. The first processor may receive affirmations from an agent that documents have been collected. Each of the affirmations may refer to a different document. The documents may include a real estate listing contract and related documents. The first processor may also store a record of the affirmations and upload the documents. The second processor may display the documents to a compliance officer and receive affirmations from the compliance officer that documents include characteristics required by standards. The second processor may also store a record of the new affirmations. If the new affirmations are not complete, then the processor may transmit a notification. If the affirmations are complete, then the processor may transmit an approval. The third processor may display the notification or the approval to the agent.

### BACKGROUND OF THE INVENTION

This invention relates generally to document inventory and verification systems and methods. More specifically the invention relates to systems and methods for verifying that real estate listing and sale documents comply with related laws, regulations, and/or standards.

Previous systems and methods known in the art for verification of documents are predominately paper based, and may allow incomplete document storage and/or verification to occur. Embodiments of the present invention provide solutions to these and other problems.

### BRIEF DESCRIPTION OF THE INVENTION

In one embodiment, a system for ensuring that a collection of digital real estate listing documents complies with a set of standards is provided. The system may include a first processor, a second processor, and a third processor. The first processor may be for receiving a first plurality of affirmations from an agent that a first plurality of documents have been collected by the agent. Each of the first plurality of affirmations may refer to a different document in the first plurality of documents. The first plurality of documents may include a real estate listing contract and a plurality of related real estate listing documents. The first processor may also be for storing a record of the first plurality of affirmations at a central digital data storage device and uploading the first plurality of documents to the central digital data storage device. The second processor may be for displaying the first plurality of documents to a compliance officer and receiving a second plurality of affirmations from the compliance officer that each of the first plurality of documents includes a characteristic required by the set of standards. The second processor may also be for storing a record of the second plurality of affirmations at the central digital data storage device. If the record of the second plurality of affirmations does not contain at least one affirmation for each of the first plurality of documents, then the second processor may transmit a notification. If the record of the second plurality of affirmations does contain at least one affirmation for each of the first plurality of documents, then the second processor may transmit an approval. The third processor may be for displaying the notification or the approval to the agent.

In another embodiment, a system for ensuring that a collection of digital real estate sale documents complies with a set of standards is provided. The system may include a first processor, a second processor, and a third processor. The first processor may be for receiving a first plurality of affirmations from an agent that a first plurality of documents have been collected by the agent. Each of the first plurality of affirmations may refer to a different document in the first plurality of documents. The first plurality of documents may include a real estate sale contract and a plurality of related real estate sale documents. The first processor may also be for storing a record of the first plurality of affirmations at a central digital data storage device and uploading the first plurality of documents to the central digital data storage device. The second processor may be for displaying the first plurality of documents to a compliance officer and receiving a second plurality of affirmations from the compliance officer that each of the first plurality of documents includes a characteristic required by the set of standards. The second processor may also be for storing a record of the second plurality of affirmations at the central digital data storage device. If the record of the second plurality of affirmations does not contain at least one affirmation for each of the first plurality of documents, then the second processor may transmit a notification. If the record of the second plurality of affirmations does contain at least one affirmation for each of the first plurality of documents, then the second processor may transmit an approval. The third processor may be for displaying the notification or the approval to the agent.

### BRIEF DESCRIPTION OF THE DRAWINGS

The present invention is described in conjunction with the appended figures:

FIG. 1 is one possible first interface of the invention, as presented by a first processor;

FIG. 2 is one possible second interface of the invention, as presented by a second processor;

FIG. 3 is one possible third and fourth interface of the invention, as presented by a processor;

FIG. 4 is another possible first interface of the invention, as presented by a first processor;

FIG. 5 is another possible second interface of the invention, as presented by a second processor; and

FIG. 6 is a block diagram of an exemplary computer system capable of being used in at least some portion of the apparatuses or systems, or capable of implementing at least some portion of the methods, of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, networks, processes, and other elements in the invention may be discussed only generally in order not to obscure the embodiments in unnecessary detail. In other instances, well-known processes, algorithms, structures, and techniques may be referred to without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc.

The term “machine-readable medium” includes, but is not limited to portable or fixed storage devices, optical storage devices, wireless channels and various other transient and non-transient mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a system for ensuring that a collection of digital real estate listing or digital real estate sale documents complies with a set of standards is provided. The system may include a first processor, a second processor, and a third processor. In some embodiments, any of the various processors may be the same or physically separate processors. For example, the first processor and the third processor may be a single physical processor, or may be distinct and separate processors. Additionally, the methods conducted by the processors herein are also thus provided by this disclosure.

In some embodiments, the set of standards may be federal or state laws, federal or state regulations, industry or trade group standards, and/or internal organization standards. These standards may dictate what type of documents are required to be present for a given transaction, and/or what must be present in the content of such documents. The contents may be both substantive (e.g., pre-execution content present in the document) and executorial (e.g., signatures or other executions).

In some embodiments, the first processor may be for receiving a first plurality of affirmations from an agent that a first plurality of documents have been collected by the agent. Each of the first plurality of affirmations may refer to a different document in the first plurality of documents. The first plurality of documents may include a real estate listing contract or sale contract and a plurality of related real estate listing or sale contract documents. The type of real estate listing or sale contract documents may be for a residential sale, a income-residential sale, a commercial sale, a vacant lot sale, a lease, a Housing and Urban Development (HUD) loan sale, a Veterans Affairs (VA) loan sale, or other government sponsored enterprise (GSE) loan sale, for example Fannie Mae. Other types of real estate listing or sale contract documents may be for a builder contract, a bank contract, or a foreclosure.

In some embodiments, the first processor may also be for storing a record of the first plurality of affirmations at a central digital data storage device and uploading the first plurality of documents to the central digital data storage device. In these or other embodiments, uploading the first plurality of documents may be accomplished by providing an open e-mail to which digital copies of the first plurality of documents can be attached. This may be done within the first processor or in addition to the first processor. The e-mail may then be sent to be received by a process which stores the attached documents at the central digital data storage device.

In some embodiments, the first processor may request further documents based on various factors. Merely by way of example, receiving a first particular affirmation referring to a first particular document may cause the first processor to request a second particular affirmation referring to a second particular document. The document itself may also be requested and be uploaded as described above.

In these or other embodiments, the first processor may also receive a set of information regarding a real estate property associated with the real estate listing contract, and this may cause the first processor to cause the first processor to request an additional particular affirmation referring to an additional particular document. The document itself may also be requested and be uploaded as described above. Merely by way of example, location information, the type of construction, and the year of construction of buildings on the real estate, and/or other characteristics of the real estate may cause the first processor to request additional affirmations and/or documents.

In some embodiments, the second processor may be for displaying the first plurality of documents to a compliance officer and receiving a second plurality of affirmations from the compliance officer that each of the first plurality of documents includes a characteristic required by the set of standards. When a processor is discussed herein as “displaying,” it may be taken to mean, in some cases, at least “causing” to be displayed (as with any action discussed herein).

In some embodiments, the characteristic required by the set of standards may merely be the presence of a particular document. In other embodiments, the particular contents of a document may be mandated by the standard, and the presence of those contents may be the characteristic required. In these or other embodiments, the required characteristic may be a signature of one or more parties to the underlying transaction. In different embodiments, different documents may have differing numbers of required characteristics which are necessary to receive a general affirmation of adequacy of the document.

In some embodiments, the second processor may also be for storing a record of the second plurality of affirmations at the central digital data storage device. If the record of the second plurality of affirmations does not contain at least one affirmation for each of the first plurality of documents, then the second processor may transmit a notification. Note that the number of affirmations required for any particular document may vary depending on the type of document. The notification may essentially be a notification that the document set is incomplete or deficient in some manner. The notification may include instructions to the agent as to why the document set is incomplete or insufficient.

If the record of the second plurality of affirmations does contain at least one affirmation for each of the first plurality of documents, then the second processor may transmit an approval. As above, more affirmations may be required for each document, depending on the document. The approval may essentially be a message that the document set complete, or at least sufficient for the underlying transaction to proceed. The approval may, in some embodiments,

In some embodiments, the third processor may be for displaying the notification or the approval to the agent. As discussed above, the first and third processor may be the same processor in some embodiments. In these or other embodiments, the third processor may also display, with the notification, at least one request for uploading of a particular document which did not receive an affirmation in the second plurality of affirmations. The third processor may further upload the particular document to the central digital data storage device.

In some embodiments, the system may also include a fourth processor for creating an electronic real estate listing based at least in part on the approval being transmitted by the third processor. Information for the electronic real estate listing may be provided by the first plurality of documents and any additional documents submitted thereafter. In embodiments where a sale is being completed, the fourth processor may instead be configured to cause cancellation of an electronic real estate listing based on the approval being transmitted by the third processor.

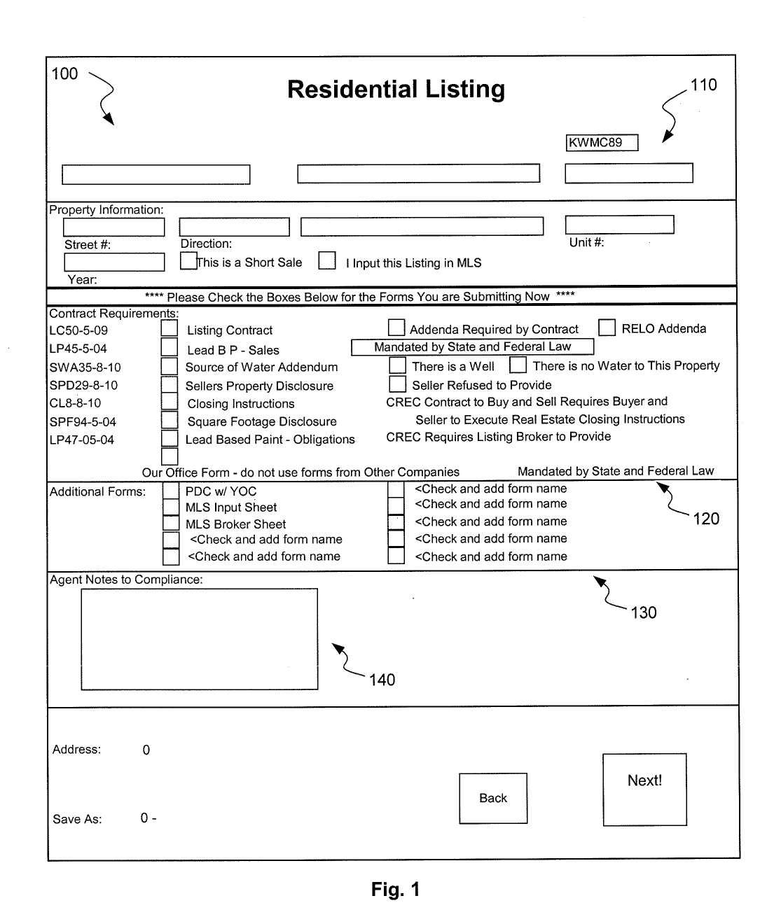

Turning now to FIG. 1, a first interface 100 of the invention, as possibly presented by a first processor is shown. Interface 100 may accept affirmations from an agent that certain documents are collected in relation to a real estate listing. Though interface 100 relates to a residential listing, other types of real estate listings could also be facilitated with interface 100, as described above. Interface 100 may allow biographic and property information to be input in a first portion 110.

Second portion 120 may allow for affirmations regarding required documents for the listing to be provided. In interface 110, check boxes which may be selected by the agent at the interface provide for affirmations to be made regarding each document. Third portion 130 may allow for affirmations regarding optional documents for the listing to be provided. Finally, fourth portion 140 may allow for notes to be provided by the agent to the compliance officer.

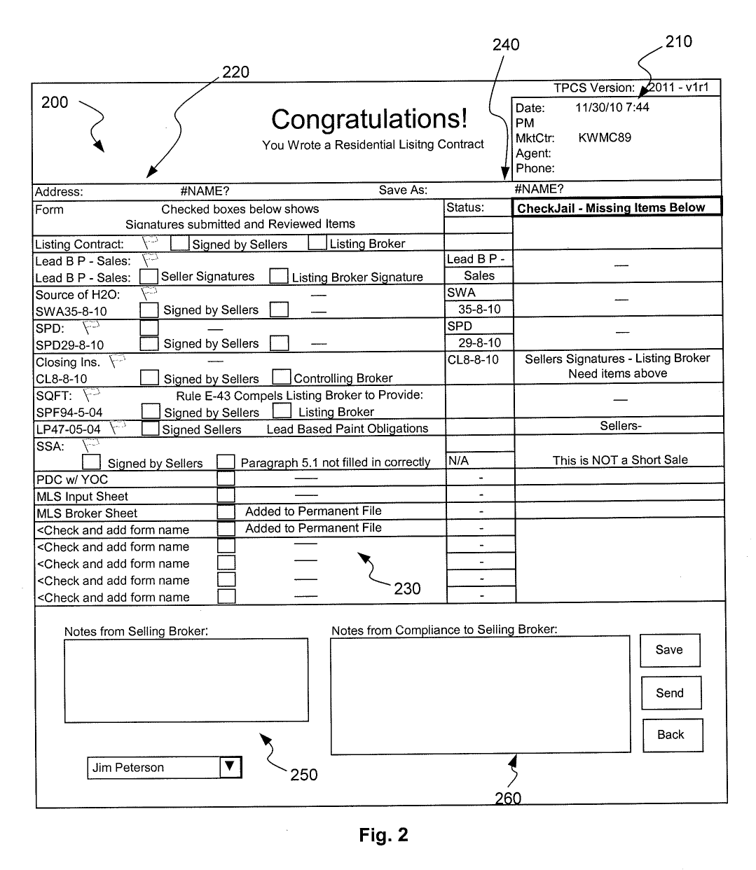

FIG. 2 shows a second interface 200 of the invention, as possibly presented by a second processor. Interface 200 may accept affirmations from a compliance officer that certain documents are both present and have the required characteristics. Interface 200 may include biographic information 210 and property information 220.

Another portion 230 of interface 200 may allow for the compliance office to provide affirmations regarding each of the documents submitted (or that should have been submitted but were not). Indicators 240 will show when a necessary affirmation is missing, including a summary that at least one necessary affirmation is missing and thus the listing documents are incomplete.

The notes from fourth portion 140 of interface 100 may allow for a message from the agent to be transmitted to the compliance office, where they will show in portion 250 of interface 200. These notes may allow the compliance officer to determine if the submitted documents are adequate and should or should not be affirmed as such. Likewise, portion 260 of interface 200 provides a location for notes from the compliance office to be provided, either for historical record, or to report back to the agent in case of missing documents and or contents of those documents.

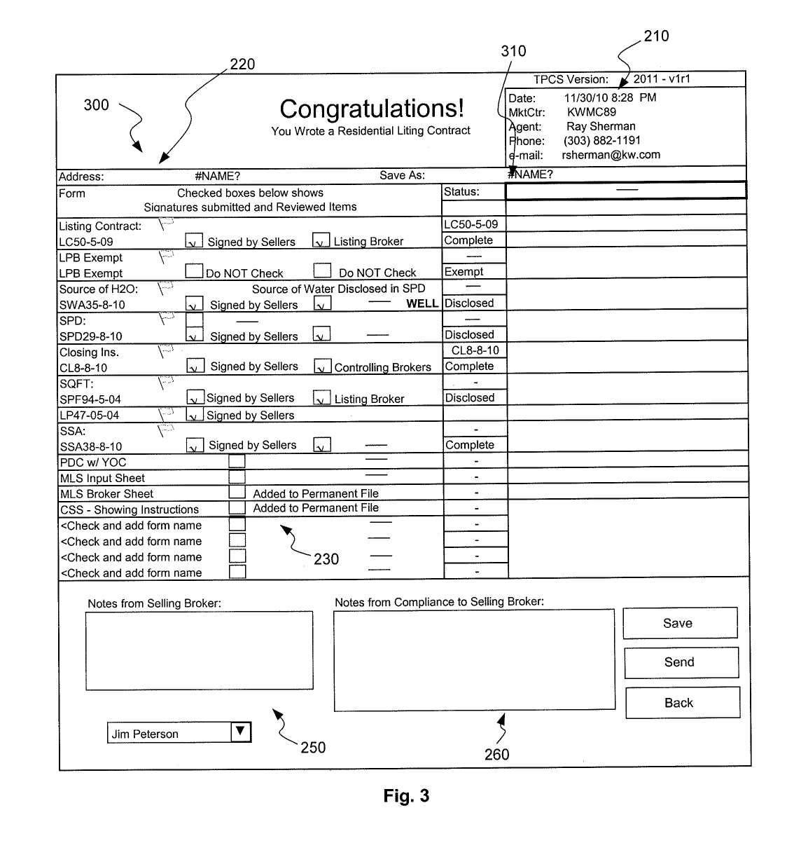

FIG. 3 shows third and fourth interface 300 of the invention, as possibly presented by a processor. Third/fourth interface 300 may have portions similar to those shown in FIG. 2, and may also have indicators 310 which show whether any portion of, or all of, the document set, as reviewed by the compliance office, is complete or incomplete. As discussed above, third/fourth interface 300 may allow for additional documents and affirmations to be submitted by the agent to retry for completion and acceptance of the document set.

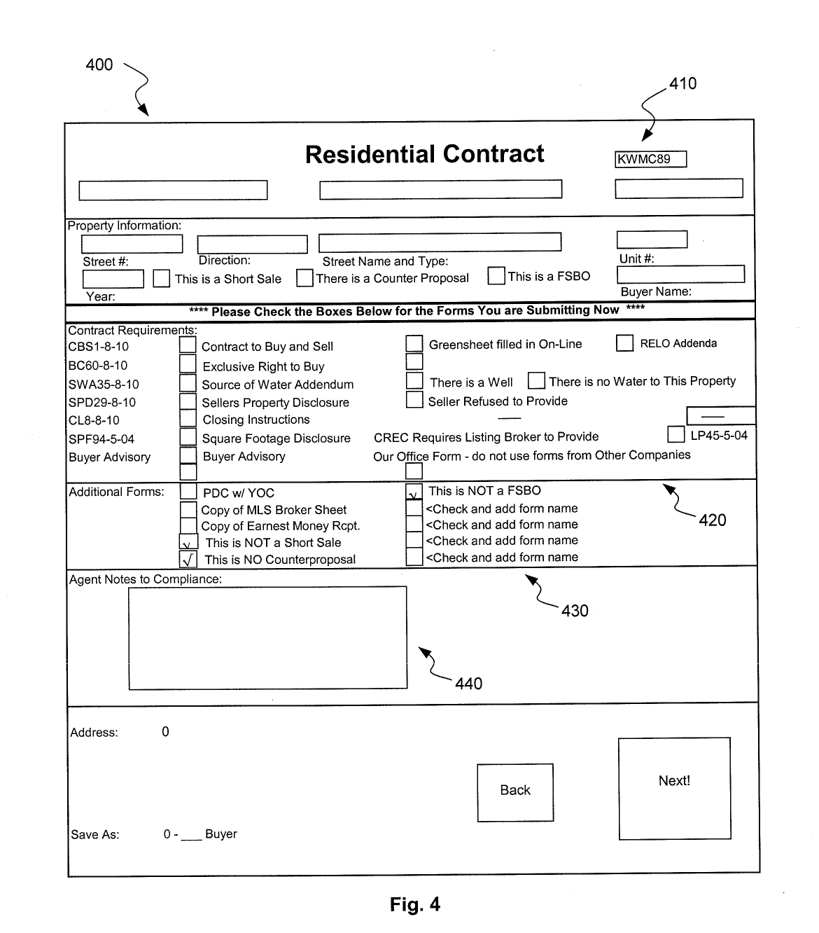

FIG. 4 another first interface 400 of the invention, as possibly presented by a first processor is shown. Interface 400 may accept affirmations from an agent that certain documents are collected in relation to a real estate sale. Though interface 400 relates to a residential sale contract, other types of real estate sales contracts could also be facilitated with interface 400, as described above. Interface 400 may allow biographic and property information to be input in a first portion 410.

Second portion 420 may allow for affirmations regarding required documents for the sale to be provided. In interface 410, check boxes which may be selected by the agent at the interface provide for affirmations to be made regarding each document. Third portion 430 may allow for affirmations regarding optional documents for the sale to be provided. Finally, fourth portion 440 may allow for notes to be provided by the agent to the compliance officer.

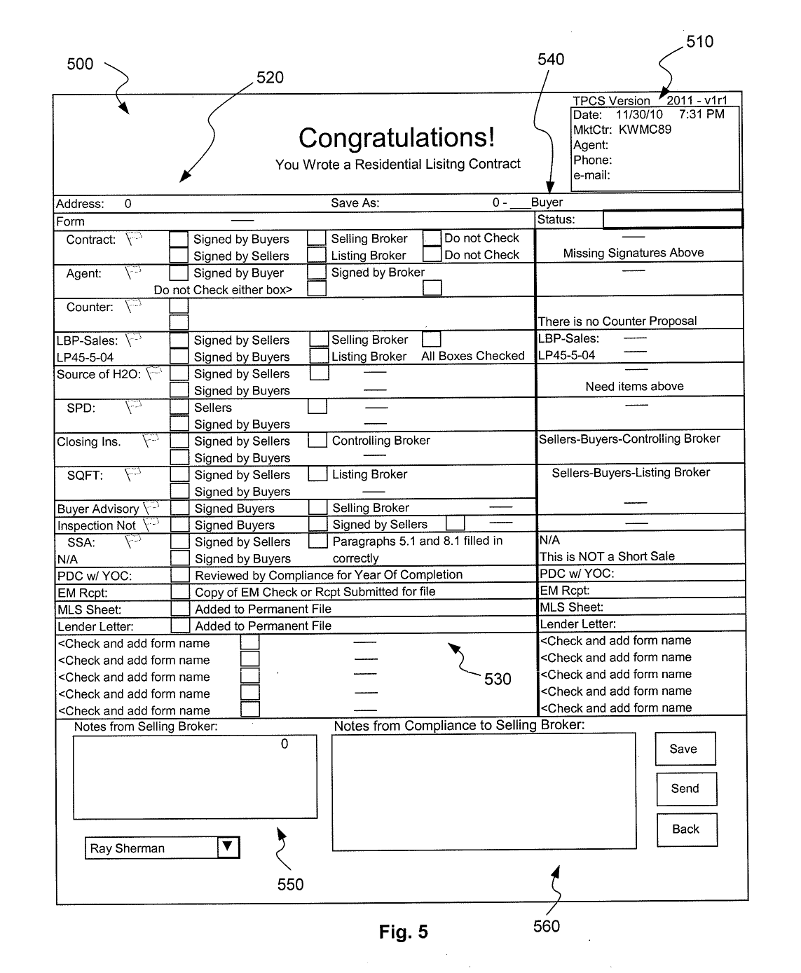

FIG. 5 shows another second interface 500 of the invention, as possibly presented by a second processor. Interface 500 may accept affirmations from a compliance officer that certain documents are both present and have the required characteristics. Interface 500 may include biographic information 510 and property information 520.

Another portion 530 of interface 500 may allow for the compliance office to provide affirmations regarding each of the documents submitted (or that should have been submitted but were not). Indicators 540 will show when a necessary affirmation is missing, including a summary that at least one necessary affirmation is missing and thus the sale documents are incomplete.

The notes from fourth portion 540 of interface 500 may allow for a message from the agent to be transmitted to the compliance office, where they will show in portion 550 of interface 500. These notes may allow the compliance officer to determine if the submitted documents are adequate and should or should not be affirmed as such. Likewise, portion 560 of interface 500 provides a location for notes from the compliance office to be provided, either for historical record, or to report back to the agent in case of missing documents and or contents of those documents.

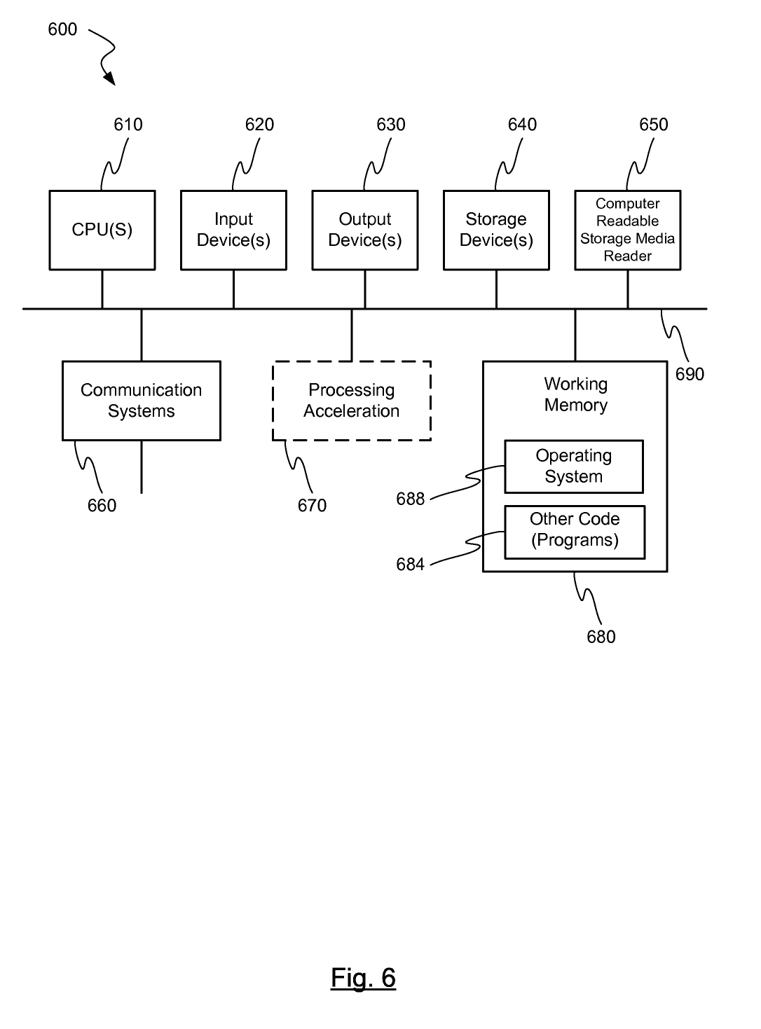

FIG. 6 is a block diagram illustrating an exemplary computer system 600 in which embodiments of the present invention may be implemented. This example illustrates a computer system 600 such as may be used, in whole, in part, or with various modifications, to provide the functions of the first processor, the second processor, the third processor, the fourth processor, the central digital data storage device, and/or other components of the invention such as those discussed above. For example, various functions of the second processor may be controlled by the computer system 600, including, merely by way of example, displaying the first plurality of documents to the compliance officer, receiving the second plurality of affirmations from the compliance officer, storing the record of the second plurality of affirmations at the central digital data storage device, determining whether the second plurality of affirmations contains at least one affirmation, transmitting notifications or approvals, etc.

The computer system 600 is shown comprising hardware elements that may be electrically coupled via a bus 690. The hardware elements may include one or more central processing units 610, one or more input devices 620 (e.g., a mouse, a keyboard, etc.), and one or more output devices 630 (e.g., a display device, a printer, etc.). The computer system 600 may also include one or more storage device 640. By way of example, storage device(s) 640 may be disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 650, a communications system 660 (e.g., a modem, a network card (wireless or wired), an infra-red communication device, Bluetooth™ device, cellular communication device, etc.), and working memory 680, which may include RAM and ROM devices as described above. In some embodiments, the computer system 600 may also include a processing acceleration unit 670, which can include a digital signal processor, a special-purpose processor and/or the like.

The computer-readable storage media reader 650 can further be connected to a computer-readable storage medium, together (and, optionally, in combination with storage device(s) 640) comprehensively representing remote, local, fixed, and/or removable storage devices plus storage media for temporarily and/or more permanently containing computer-readable information. The communications system 660 may permit data to be exchanged with a network, system, computer and/or other component described above.

The computer system 600 may also comprise software elements, shown as being currently located within a working memory 680, including an operating system 684 and/or other code 688. It should be appreciated that alternate embodiments of a computer system 600 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 600 may include code 688 for implementing any or all of the function of the various elements of the architecture as described herein. For example, software, stored on and/or executed by a computer system such as system 600, can provide the functions of the first processor, the second processor, the third processor, the fourth processor, the central digital data storage device, and/or other components of the invention such as those discussed above. Methods implementable by software on some of these components have been discussed above in more detail.

A number of variations and modifications of the invention can also be used within the scope of the invention. For example, the same systems and methods described herein could be applied to other document based systems, for example securities purchases and/or loan documents (real estate or otherwise).

The invention has now been described in detail for the purposes of clarity and understanding. However, it will be appreciated that certain changes and modifications may be practiced within the scope of the appended claims.

What is claimed is:

1. A system for ensuring that a collection of digital real estate listing documents complies with a set of standards, wherein the system comprises:
(I) a first processor for:
(A) receiving a first plurality of affirmations from an agent that a first plurality of documents have been collected by the agent,
(1) each of the first plurality of affirmations referring to a different document in the first plurality of documents, and
(2) the first plurality of documents comprising a real estate listing contract and a plurality of related real estate listing documents;
(B) storing a record of the first plurality of affirmations at a central digital data storage device; and
(C) uploading the first plurality of documents to the central digital data storage device;
(II) a second processor for:
(A) displaying the first plurality of documents to a compliance officer;
(B) receiving a second plurality of affirmations from the compliance officer that each of the first plurality of documents comprises a characteristic required by the set of standards;
(C) storing a record of the second plurality of affirmations at the central digital data storage device;
(D) if the record of the second plurality of affirmations does not contain at least one affirmation for each of the first plurality of documents, then transmitting a notification; and
(E) if the record of the second plurality of affirmations does contain at least one affirmation for each of the first plurality of documents, then transmitting an approval; and
(III) a third processor for:
(A) displaying the notification or the approval to the agent.

2. The system for ensuring that a collection of digital real estate listing documents complies with a set of standards of claim 1, wherein receiving the first plurality of affirmations from the agent that the first plurality of documents have been collected by the agent comprises:
(1) receiving a first particular affirmation referring to a first particular document; and
(2) requesting a second particular affirmation referring to a second particular document.

3. The system for ensuring that a collection of digital real estate listing documents complies with a set of standards of claim 1, wherein uploading the first plurality of documents to the central digital data storage device comprises:
(1) providing an open e-mail to which digital copies of the first plurality of documents can be attached; and
(2) sending the e-mail to central digital data storage device.

4. The system for ensuring that a collection of digital real estate listing documents complies with a set of standards of claim 1, wherein the first processor is further for:
(D) receiving a set of information regarding a real estate property associated with the real estate listing contract; and
(E) requesting a first particular affirmation referring to a first particular document based at least in part on the set of information.

5. The system for ensuring that a collection of digital real estate listing documents complies with a set of standards of claim 1, wherein the first processor is further for:
(D) requesting at least one additional affirmation from the agent that at least one additional optional document has been collected by the agent;
(E) storing a record of the at least one additional affirmation at the central digital data storage device; and
(F) uploading the at least one additional optional document to the central digital data storage device.

6. The system for ensuring that a collection of digital real estate listing documents complies with a set of standards of claim 1, wherein the third processor is further for:
(B) displaying, with the notification, at least one request for uploading of a particular document which did not receive an affirmation in the second plurality of affirmations; and
(C) uploading the particular document to the central digital data storage device.

7. The system for ensuring that a collection of digital real estate listing documents complies with a set of standards of claim 1, wherein the characteristic required by the set of standards comprises the presence of a particular document.

8. The system for ensuring that a collection of digital real estate listing documents complies with a set of standards of claim 1, wherein the characteristic required by the set of standards comprises a signature of at least one party.

9. The system for ensuring that a collection of digital real estate listing documents complies with a set of standards of claim 1, wherein the system further comprises:
(IV) a fourth processor for creating an electronic real estate listing based at least in part on:
(A) the approval; and
(B) the first plurality of documents.

10. The system for ensuring that a collection of digital real estate listing documents complies with a set of standards of claim 1, wherein the first processor and the third processor are the same physical processor.

11. A method for ensuring that a collection of digital real estate sale documents complies with a set of standards, wherein the method comprises:
(I) with a first processor:
(A) receiving a first plurality of affirmations from an agent that a first plurality of documents have been collected by the agent,
(1) each of the first plurality of affirmations referring to a different document in the first plurality of documents, and
(2) the first plurality of documents comprising a real estate sale contract and a plurality of related real estate sale documents;
(B) storing a record of the first plurality of affirmations at a central digital data storage device; and
(C) uploading the first plurality of documents to the central digital data storage device;
(II) with a second processor:
(A) displaying the first plurality of documents to a compliance officer;
(B) receiving a second plurality of affirmations from the compliance officer that each of the first plurality of documents comprises a characteristic required by the set of standards;
(C) storing a record of the second plurality of affirmations at the central digital data storage device;
(D) if the record of the second plurality of affirmations does not contain at least one affirmation for each of the first plurality of documents, then transmitting a notification; and
(E) if the record of the second plurality of affirmations does contain at least one affirmation for each of the first plurality of documents, then transmitting an approval; and
(III) with a third processor:
(A) displaying the notification or the approval to the agent.

12. The method for ensuring that a collection of digital real estate sale documents complies with a set of standards of claim 11, wherein receiving the first plurality of affirmations from the agent that the first plurality of documents have been collected by the agent comprises:
(1) receiving a first particular affirmation referring to a first particular document; and
(2) requesting a second particular affirmation referring to a second particular document.

13. The method for ensuring that a collection of digital real estate sale documents complies with a set of standards of claim 11, wherein uploading the first plurality of documents to the central digital data storage device comprises:
(1) providing an open e-mail to which digital copies of the first plurality of documents can be attached; and
(2) sending the e-mail to central digital data storage device.

14. The method for ensuring that a collection of digital real estate sale documents complies with a set of standards of claim 11, wherein the method further comprises, with the first processor:
(D) receiving a set of information regarding a real estate property associated with the real estate sale contract; and
(E) requesting a first particular affirmation referring to a first particular document based at least in part on the set of information.

15. The method for ensuring that a collection of digital real estate sale documents complies with a set of standards of claim 11, wherein the method further comprises, with the first processor:
(D) requesting at least one additional affirmation from the agent that at least one additional optional document has been collected by the agent;
(E) storing a record of the at least one additional affirmation at the central digital data storage device; and
(F) uploading the at least one additional optional document to the central digital data storage device.

16. The method for ensuring that a collection of digital real estate sale documents complies with a set of standards of claim 11, wherein the method further comprises, with the third processor:
(B) displaying, with the notification, at least one request for uploading of a particular document which did not receive an affirmation in the second plurality of affirmations; and
(C) uploading the particular document to the central digital data storage device.

17. The method for ensuring that a collection of digital real estate sale documents complies with a set of standards of claim 11, wherein the characteristic required by the set of standards comprises the presence of a particular document.

18. The method for ensuring that a collection of digital real estate sale documents complies with a set of standards of claim 11, wherein the characteristic required by the set of standards comprises a signature of at least one party.

19. The method for ensuring that a collection of digital real estate sale documents complies with a set of standards of claim 11, wherein the method further comprises, with (IV) a fourth processor:
(A) canceling an electronic real estate listing based at least in part on:
(1) the approval; and
(2) the first plurality of documents.

20. The method for ensuring that a collection of digital real estate sale documents complies with a set of standards of claim 11, wherein the second processor and the third processor are not the same physical processor.
